(19) United States
(12) Patent Application Publication
(10) Pub. No.: US 2020/0082337 A1
(43) Pub. Date: Mar. 12, 2020

(54) ATTRIBUTE-BASED MATERIAL DETERMINATIONS AND ASSIGNMENTS

(71) Applicant: International Business Machines Corporation, Armonk, NY (US)

(72) Inventors: Clinton W. Erie, Adams, MN (US); David J. Fichtinger, Rochester, MN (US); Kerrie A. Grant, Raleigh, NC (US); Ryan Paske, Rochester, MN (US)

(21) Appl. No.: 16/127,641

(22) Filed: Sep. 11, 2018

(51) Int. Cl. G06Q 10/08; G06F 17/30; G06Q 10/06

(52) U.S. Cl. CPC G06Q 10/0875; G06Q 10/06313; G06F 17/30946

(57) ABSTRACT

A computer-implemented method of determining and assigning ownership of a bill of material (BOM) and/or a part number (PN) is provided. The computer-implemented method includes determining whether elements affected by an engineering change (EC) are BOMs or PNs, compiling the BOMs and PNs into respective lists of BOMs and PNs and setting each of the BOMs and PNs in the respective lists as top BOMs or top PNs if a parent BOM does not exist, setting each parent BOM and each PN to which attribute rules are inapplicable as top BOMs or top PNs. The computer-implemented method further includes assigning the top BOMs and the top PNs if no assignments of ownership exist, executing recursive logic with respect to each top BOM to identify child BOMs and PNs and assigning ownership to the identified child BOMs and PNs if no assignment of ownership exists.

### BACKGROUND

The present invention generally relates to ownership determinations and assignments, and more specifically, to a series of infinitely expanding attributes used to determine and assign ownership of a bill of material (BOM) and/or a part number (PN).

A supply chain is a complex and dynamic supply and demand network. More specifically, a supply chain is a system of organizations, people, activities, information, and resources that are involved in moving products or services from suppliers to customers. Supply chain activities involve the transformation of natural resources, raw materials, and components into finished products that are ultimately delivered to an end customer.

### SUMMARY

Embodiments of the present invention are directed to a computer-implemented method of determining and assigning ownership of a bill of material (BOM) and/or a part number (PN). A non-limiting example of the computer-implemented method includes determining whether elements affected by an engineering change (EC) are BOMs or PNs, compiling the BOMs and PNs into respective lists of BOMs and PNs and setting each of the BOMs and PNs in the respective lists as top BOMs or top PNs if a parent BOM does not exist, setting each parent BOM and each PN to which attribute rules are inapplicable as top BOMs or top PNs. The non-limiting example of the computer-implemented method further includes assigning the top BOMs and the top PNs if no assignments of ownership exist, executing recursive logic with respect to each top BOM to identify child BOMs and PNs and assigning ownership to the identified child BOMs and PNs if no assignment of ownership exists.

Embodiments of the present invention are directed to a computer program product for determining and assigning ownership of a bill of material (BOM) and/or a part number (PN). A non-limiting example of the computer program product includes a processor and a memory having executable instructions stored thereon, which, when executed by the processor, cause the processor to execute a method. The method includes determining whether elements affected by an engineering change (EC) are BOMs or PNs, compiling the BOMs and PNs into respective lists of BOMs and PNs, setting each of the BOMs and PNs in the respective lists as top BOMs or top PNs if a parent BOM does not exist and setting each parent BOM and each PN to which attribute rules are inapplicable as top BOMs or top PNs. The method further includes assigning the top BOMs and the top PNs if no assignments of ownership exist, executing recursive logic with respect to each top BOM to identify child BOMs and PNs and assigning ownership to the identified child BOMs and PNs if no assignment of ownership exists.

Embodiments of the present invention are directed to a system of determining and assigning ownership of a bill of material (BOM) and/or a part number (PN). A non-limiting example of the system includes a supply chain in which development teams release BOMs and PNs and a computing system configured to determine, assign and track the ownership of the BOMs and the PNs. The computing system is configured to determine whether elements affected by an engineering change (EC) are BOMs or PNs, compile the BOMs and PNs into respective lists of BOMs and PNs, set each of the BOMs and PNs in the respective lists as top BOMs or top PNs if a parent BOM does not exist and set each parent BOM and each PN to which attribute rules are inapplicable as top BOMs or top PNs. The computing system is further configured to assign the top BOMs and the top PNs if no assignments of ownership exist, execute recursive logic with respect to each top BOM to identify child BOMs and PNs and assign ownership to the identified child BOMs and PNs if no assignment of ownership exists.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a schematic diagram of a supply chain in accordance with embodiments of the present invention;

FIG. 4 is a schematic diagram of a computing system in accordance with embodiments of the present invention;

FIG. 5 is a flow diagram illustrating a method of determining and assigning ownership of a bill of material (BOM) and/or a part number (PN) in accordance with embodiments of the present invention;

FIG. 6 is a flow diagram illustrating a method of determining and assigning ownership of a bill of material (BOM) and/or a part number (PN) in accordance with embodiments of the present invention;

FIG. 7 is a flow diagram illustrating a method of top code assignment in accordance with embodiments of the present invention;

FIG. 8 is a flow diagram illustrating a method of lower code assignment in accordance with embodiments of the present invention; and

FIG. 9 is a flow diagram illustrating a method of part code assignment in accordance with embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

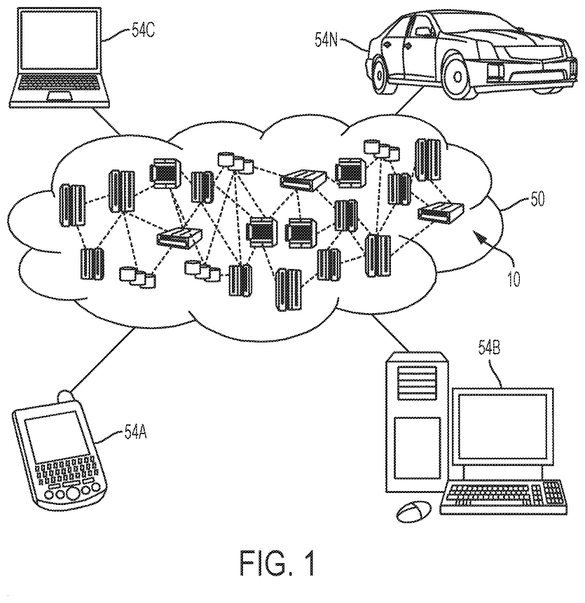

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

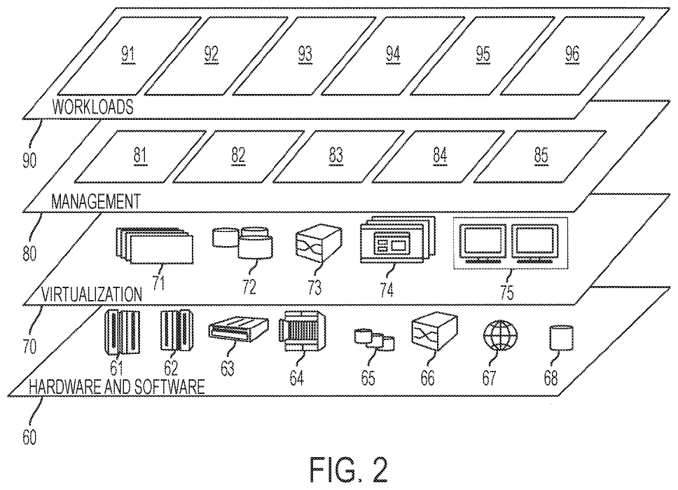

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the determining and assigning of a BOM and/or a PN using infinitely expanding attributes 96.

Turning now to an overview of technologies that are more specifically relevant to aspects of the invention, a bill of materials or product structure (hereinafter referred to as a “BOM”) is a list of raw materials, sub-assemblies, intermediate assemblies, sub-components, parts and the quantities of each that are needed to manufacture an end product. A BOM can be used for communication between manufacturing partners or can be confined to a single manufacturing plant. In some cases, a BOM can be tied to a production order whose issuance generates reservations for components in the BOM that are in stock and requisitions for components that are not in stock. A BOM can thus define products as they are designed (engineering BOM), as they are ordered (sales BOM), as they are built (manufacturing BOM) or as they are maintained (service BOM). The different types of BOMs depend on business needs and uses for which they are intended. A part number (hereinafter referred to as a “PN”) is an identifier of a particular part design used in a particular industry to simplify reference to that part.

When new BOMs and/or PNs are released in a given situation, they often need to be assigned an owner who is responsible for a series of setups of assigned part numbers as well as a number of key process controls (e.g., initial data set up of the BOM/PN, future set up of engineering changes, cost estimations for scrap and establishment of contact or quality issues). In some cases, there can be multiple owners of a part associated with a BOM/PN, with each owner representing a different role.

Currently, determining and assigning BOM/PN ownership is typically accomplished through a manual, one-by-one process. This can be time-consuming and prone to error.

Turning now to an overview of the aspects of the invention, one or more embodiments of the invention address the above-described shortcomings of the prior art by providing for an automated system and method to determine and assign BOM and/or PN ownership. While a definition of a BOM or a PN is typically predetermined or preset by a user, in this case, a series of algorithms automatically determine what a BOM is versus a PN utilizing recursive functionality and allows for the explosion through many (infinite) layers of product structure if needed to make a determination. In addition, an infinite number of part ownership assignments is possible with each assignment denoting specific roles or work associated to a part. An algorithm combined with priority, engineering changes attributes, and material attributes will define ownership automatically as the engineering changes are loaded.

The above-described aspects of the invention address the shortcomings of the prior art by making use of a series of infinitely expandable attributes to determine and assign BOM and/or PN ownership. An algorithm, using recursive functionality, systematically explodes a product structure to determine which materials are BOMs and which materials are PNs. A set of engineering change and material attributes that can be used to define various types of BOMs or PNs is established. A rules table then defines ownership using priority, engineering change attributes, rule groups and commodities and is infinitely expandable (i.e., 1→n owners may be assigned based on numbers of work activities that need to be distributed). A material attribute table utilizes part attributes to group parts into commodities. Once an assignment of a code has been made it becomes re-usable as additional engineering changes are processed against that material.

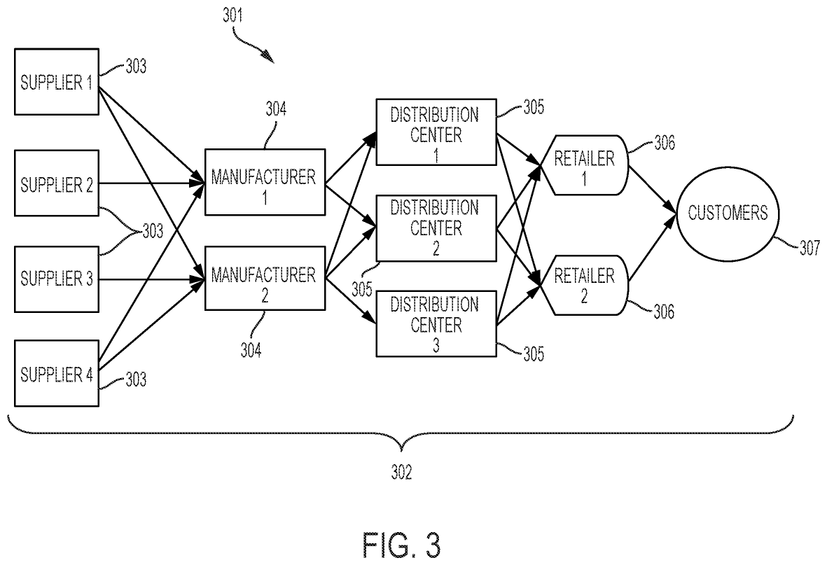

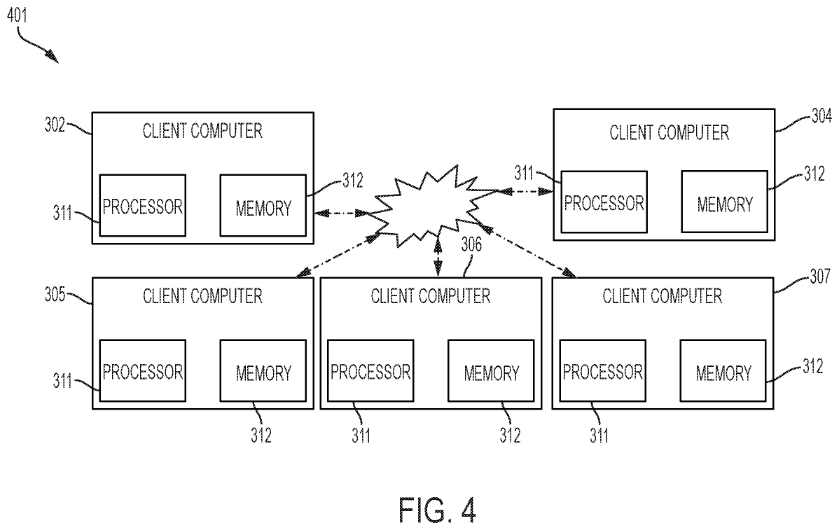

With reference to FIG. 3, a system 301 is provided for the determining and assigning of ownership of BOMs and/or PNs. The system 301 includes a supply chain 302 in which development teams develop, test and ultimately release for distribution products that are identifiable by various BOMs and PNs. As shown in FIG. 3, the supply chain 302 includes suppliers 303, manufacturers 304, distribution centers 305, retailers 306 and customers 307. The suppliers 303 supply raw materials and parts to the manufacturers 304 and the manufacturers 304 assemble those raw materials and parts into the products. Once assembled, the products are shipped from the manufacturers 304 to the distribution centers 305 and from the distribution centers 305 to the retailers 306. The retailers 306 sell the products to the customers 307. At each layer of the supply chain 302, the various individuals and entities can be communicative with each other by way of a computing system (see FIG. 4) and client computers 310. Such communications allow the various individuals and entities to, among other things, submit orders, fulfill orders and generate engineering changes (ECs). In some cases, the ECs can be used by the suppliers 303 and the manufacturers 304 to update and improve the products. This often requires that certain individuals take ownership of a particular EC to see that it is executed and achieved. Those certain individuals need to be selected based on multiple factors including availability and competency.

With reference to FIG. 4, a computing system 401 is provided and is configured to determine, assign and track the ownership of the BOMs and the PNs for executing ECs in particular. The computing system 401 can be provided as a computer program product that is embodied in the client computers 310 and includes a processor 311 and a memory 312. The memory 312 has executable instructions stored thereon which are readable and executable by the processors 311. When the executable instructions are read and executed by the processor 311, the executable instructions cause the processor 311 to execute a method.

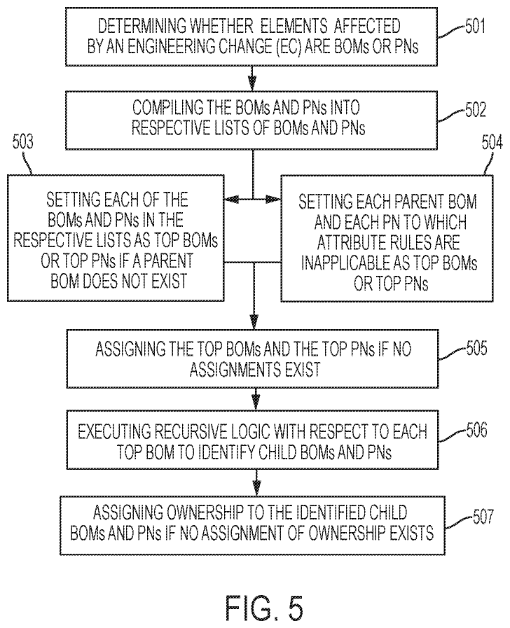

With reference to FIG. 5 and in accordance with embodiments, the method includes determining whether elements affected by an engineering change (EC) are BOMs or PNs (501) and compiling the BOMs and PNs into respective lists of BOMs and PNs (502). The method can further include setting each of the BOMs and PNs in the respective lists as top BOMs or top PNs if a parent BOM does not exist (503) and setting each parent BOM and each PN to which attribute rules are inapplicable as top BOMs or top PNs (504). In addition, the method can include assigning ownership to the top BOMs and the top PNs if no assignments of ownership exist (505), executing recursive logic with respect to each top BOM to identify child BOMs and PNs (506) and assigning ownership to the identified child BOMs and PNs if no assignment ownership exists (507).

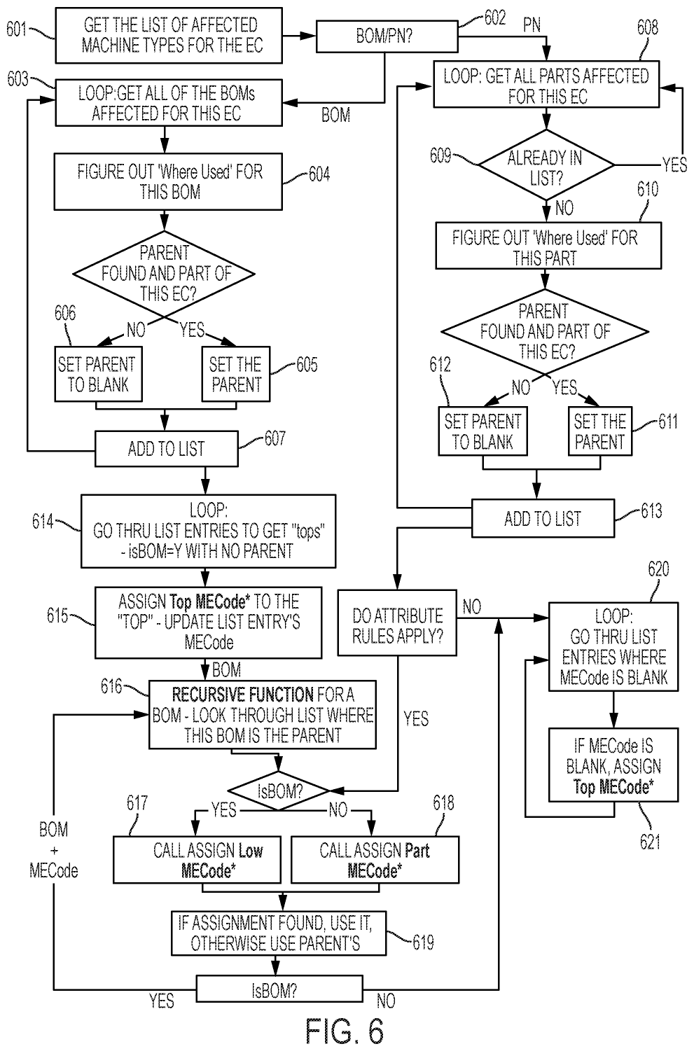

With reference to FIG. 6, a more detailed flow diagram of the implemented method is depicted. As shown in FIG. 6, the method initially includes an obtaining of a list of affected machines for a given EC (601) and determining whether each element in the list in a BOM or a PN (602).

If an element is a BOM, the method includes an action whereby each affected BOM for the given EC is obtained (603) and a determination of where the BOM is used in the corresponding supply chain (604). If the determining indicates that the BOM has a parent BOM in the supply chain and that the parent BOM is one of the affected elements of the EC, a parent field associated with the BOM is set to refer to the parent BOM (605). Conversely, if the determining indicates that the BOM does not have a parent BOM in the supply chain or that the parent BOM is not one of the affected elements of the EC, the parent field associated with the BOM is set to blank (606). In either case, the BOM is added to the list of each affected BOM for the given EC (607).

If an element is a BOM, the method includes an action whereby each affected BOM for the given EC is obtained (603) and a determination of where the BOM is used in the corresponding supply chain (604). If the determining indicates that the BOM has a parent BOM in the supply chain and that the parent BOM is one of the affected elements of the EC, a parent field associated with the BOM is set to refer to the parent BOM (605). Conversely, if the determining indicates that the BOM does not have a parent BOM in the supply chain or that the parent BOM is not one of the affected elements of the EC, the parent field associated with the BOM is set to blank (606). In either case, the BOM is added to the list of each affected BOM for the given EC (607).

If an element is a PN, the method includes an action whereby each affected PN for the given EC is obtained (608), a determination of whether each affected PN is already listed (609) and a determination of where the PN is used in the corresponding supply chain (610). If the determining indicates that the PN has a parent BOM in the supply chain and that the parent BOM is one of the affected elements of the EC, a parent field associated with the PN is set to refer to the parent BOM (611). Conversely, if the determining indicates that the PN does not have a parent BOM in the supply chain or that the parent BOM is not one of the affected elements of the EC, the parent field associated with the PN is set to blank (612). In either case, the PN is added to the list of each affected PN for the given EC (613).

For each affected BOM for the given EC, the method also includes identifying those BOMs which do not have parent BOMs (614) and setting a top code for them (615). At this point, the method includes an application of recursive logic to determine, for each BOM set with the top code, contents of trees emanating from the BOMs set with the top code (616). Here, the contents being determined include the BOMs and the PNs for which attribute rules apply that are categorized under the BOM set with the top code. Once the contents are determined, the identified BOMs are set with a low-level code (617) and the identified PNs are set with a part code (618). Then, if an assignment of each of the identified BOMs and each of the identified PNs is found, it is used or, if not, the parent BOM assignment is used (619). For the identified BOMs, the recursive logic is then re-executed.

For the identified PNs and the PNs for which attribute rules do not apply, PNs which have their parent field set to blank are found (620) and set with top codes (621).

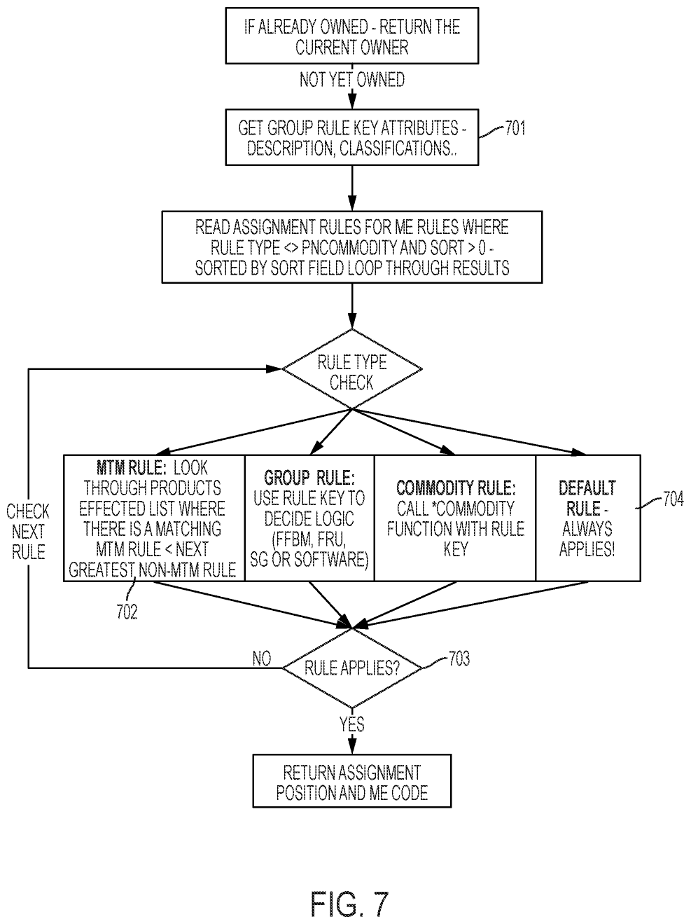

With reference to FIG. 7, the assigning of each of the PNs with top codes (see 621 of FIG. 6) includes assigning the top PN based on a read value if the top PN is a machine, obtaining group rule key attributes (i.e., descriptions and classifications), reading group rules and analyzing the PNs based on first attributes if the top PN is not a machine (701). The assigning further includes reading commodity rules (e.g., looking through affected PN list where there is a matching rule, using group rule key to decide logic, etc.) (702) and analyzing based on second attributes if the top PN is not found in group rules (703). The assigning also includes applying a default ownership rule if the top PN is not found in the commodity rule (704). Here, the group and commodity rules and the first and second attributes can be defined in group rule and commodity tables, which are stored in the memory 312 (see FIG. 4).

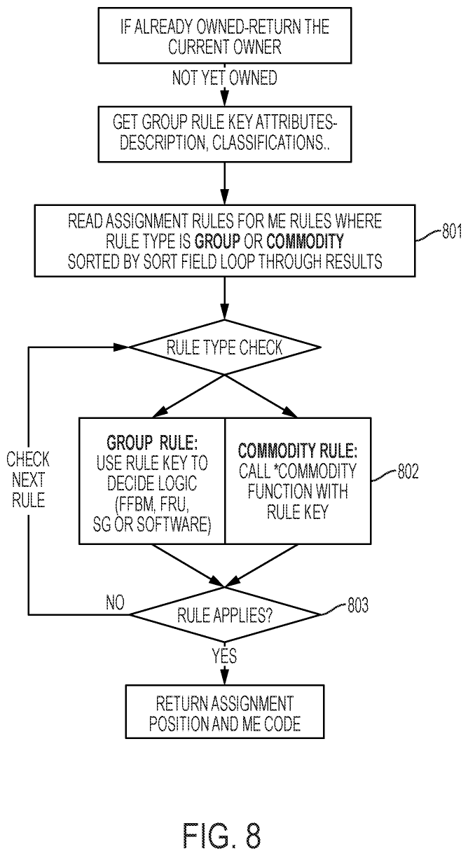

With reference to FIG. 8, the assigning of each of the child BOMs with low-level codes (see 617 of FIG. 6) includes obtaining group rule key attributes (i.e., descriptions and classifications), reading group rules and analyzing the child BOMs based on attributes (801). The assigning further includes reading commodity rules (e.g., using group rule key to decide logic, etc.) (802) and analyzing based on attributes if the child BOM is not found in group rules (803). As above, the assigning also includes applying a default ownership rule if the child BOM is not found in the commodity rule. Here, again, the group and commodity rules and the attributes can be defined in group rule and commodity tables, which are stored in the memory 312 (see FIG. 4).

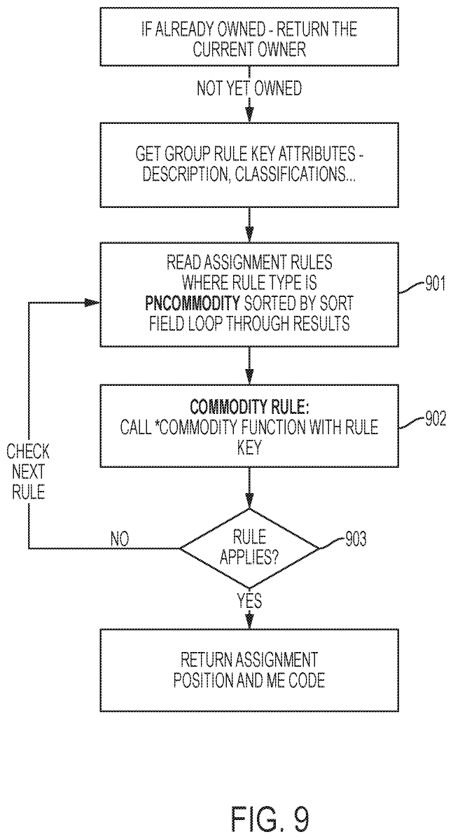

With reference to FIG. 9, the assigning of each of the child PNs with part codes (see 618 of FIG. 6) includes obtaining group rule key attributes (i.e., descriptions and classifications), reading group rules and analyzing the child PNs based on attributes (901). The assigning further includes reading commodity rules (e.g., using group rule key to decide logic, etc.) (902) and analyzing based on attributes if the child PN is not found in group rules (903). As above, the assigning also includes applying a default ownership rule if the child PN is not found in the commodity rule. Here, the group and commodity rules and the attributes can be defined in group rule and commodity tables, which are stored in the memory 312 (see FIG. 4).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of determining and assigning ownership of a bill of material (BOM) and/or a part number (PN), the computer-implemented method comprising:
determining whether elements affected by an engineering change (EC) are BOMs or PNs;
compiling the BOMs and PNs into respective lists of BOMs and PNs;
setting each of the BOMs and PNs in the respective lists as top BOMs or top PNs based on a determination that a parent BOM does not exist;
setting each parent BOM and each PN to which attribute rules are inapplicable as top BOMs or top PNs;
assigning the top BOMs and the top PNs based on a determination that no assignments of ownership exist;
executing recursive logic with respect to each top BOM to identify child BOMs and PNs; and
assigning ownership to the identified child BOMs and PNs based on a determination that no assignment of ownership exists.

2. The computer-implemented method according to claim 1, wherein the assigning of each of the top PNs comprises:
based on a determination that the top PN is a machine, assigning the top PN based on a read value;
based on a determination that the top PN is not a machine, reading group rules and analyzing based on first attributes;
based on a determination that the top PN is not found in group rules, reading commodity rules and analyzing based on second attributes; and
based on a determination that the top PN is not found in the commodity rules, applying a default ownership rule.

3. The computer-implemented method according to claim 2, wherein:
the group and commodity rules are defined in group rule tables,
the first and second attributes are defined in commodity tables, and
the group rule and commodity tables are stored in a computing system storage unit.

4. The computer-implemented method according to claim 1, wherein the assigning of each of the identified child BOMs comprises:
reading group rules and analyzing based on attributes;
based on a determination that the child BOM is not found in group rules, reading commodity rules and analyzing based on attributes; and
based on a determination that the child BOM is not found in the commodity rules, applying a default ownership rule.

5. The computer-implemented method according to claim 4, wherein:
the group and commodity rules are defined in group rule tables,
the attributes are defined in commodity tables, and
the group rule and commodity tables are stored in a computing system storage unit.

6. The computer-implemented method according to claim 1, wherein the assigning of each of the identified child PNs comprises:
reading commodity rules and analyzing based on attributes; and
based on a determination that the child PN is not found in the commodity rules, applying a default ownership rule.

7. The computer-implemented method according to claim 6, wherein:
the commodity rules are defined in a commodity rule table,
the attributes are defined in a commodity table and
the commodity rule table and the commodity table are stored in a computing system storage unit.

8. A computer program product for determining and assigning ownership of a bill of material (BOM) and/or a part number (PN), the computer program product comprising:
a processor; and
a memory having executable instructions stored thereon, which, when executed by the processor, cause the processor to execute a method comprising:
determining whether elements affected by an engineering change (EC) are BOMs or PNs;
compiling the BOMs and PNs into respective lists of BOMs and PNs;
setting each of the BOMs and PNs in the respective lists as top BOMs or top PNs based on a determination that a parent BOM does not exist;
setting each parent BOM and each PN to which attribute rules are inapplicable as top BOMs or top PNs;
assigning the top BOMs and the top PNs based on a determination that no assignments of ownership exist;
executing recursive logic with respect to each top BOM to identify child BOMs and PNs; and
assigning ownership to the identified child BOMs and PNs based on a determination that no assignment of ownership exists.

9. The computer program product according to claim 8, wherein the assigning of each of the top PNs comprises:
based on a determination that the top PN is a machine, assigning the top PN based on a read value;
based on a determination that the top PN is not a machine, reading group rules and analyzing based on first attributes;
based on a determination that the top PN is not found in group rules, reading commodity rules and analyzing based on second attributes; and
based on a determination that the top PN is not found in the commodity rules, applying a default ownership rule.

10. The computer program product according to claim 9, wherein:
the group and commodity rules are defined in group rule tables,
the first and second attributes are defined in commodity tables, and
the group rule and commodity tables are stored in a storage unit of the memory.

11. The computer program product according to claim 8, wherein the assigning of each of the identified child BOMs comprises:
reading group rules and analyzing based on attributes;
based on a determination that the child BOM is not found in group rules, reading commodity rules and analyzing based on attributes; and
based on a determination that the child BOM is not found in the commodity rules, applying a default ownership rule.

12. The computer program product according to claim 11, wherein:
the group and commodity rules are defined in group rule tables,
the attributes are defined in commodity tables, and
the group rule and commodity tables are stored in a storage unit of the memory.

13. The computer program product according to claim 8, wherein the assigning of each of the identified child PNs comprises:
reading commodity rules and analyzing based on attributes; and
based on a determination that the child PN is not found in the commodity rules, applying a default ownership rule.

14. The computer program product according to claim 13, wherein:
the commodity rules are defined in a commodity rule table,
the attributes are defined in a commodity table and
the commodity rule table and the commodity table are stored in a storage unit of the memory.

15. A system of determining and assigning ownership of a bill of material (BOM) and/or a part number (PN), the system comprising:
a supply chain in which development teams release BOMs and PNs; and
a computing system configured to determine, assign and track the ownership of the BOMs and the PNs, the computing system being configured to:
determine whether elements affected by an engineering change (EC) are BOMs or PNs;
compile the BOMs and PNs into respective lists of BOMs and PNs;
set each of the BOMs and PNs in the respective lists as top BOMs or top PNs based on a determination that a parent BOM does not exist;
set each parent BOM and each PN to which attribute rules are inapplicable as top BOMs or top PNs;
assign the top BOMs and the top PNs based on a determination that no assignments of ownership exist;
execute recursive logic with respect to each top BOM to identify child BOMs and PNs; and
assign ownership to the identified child BOMs and PNs if no assignment of ownership exists.

16. The system according to claim 15, wherein the computing system assigns each of the top PNs by:
assigning the top PN based on a read value based on a determination that the top PN is a machine;
reading group rules and analyzing based on first attributes based on a determination that the top PN is not a machine;
reading commodity rules and analyzing based on second attributes if the top PN is not found in group rules; and
applying a default ownership rule based on a determination that the top PN is not found in the commodity rules.

17. The system according to claim 16, wherein:
the group and commodity rules are defined in group rule tables,
the first and second attributes are defined in commodity tables, and
the group rule and commodity tables are stored in a storage unit of the computing system.

18. The system according to claim 15, wherein the computing system assigns each of the identified child BOMs by:
reading group rules and analyzing based on attributes;
reading commodity rules and analyzing based on attributes based on a determination that the child BOM is not found in group rules; and
applying a default ownership rule based on a determination that the child BOM is not found in the commodity rules.

19. The system according to claim 18, wherein:
the group and commodity rules are defined in group rule tables,
the attributes are defined in commodity tables, and
the group rule and commodity tables are stored in a storage unit of the computing system.

20. The system according to claim 15, wherein the computing system assigns each of the identified child PNs by:
reading commodity rules and analyzing based on attributes; and
applying a default ownership rule based on a determination that the child PN is not found in the commodity rules.
